(19) United States
(12) Patent Application Publication
(10) Pub. No.: US 2026/0145660 A1
(43) Pub. Date: May 28, 2026

(54) BRAKE APPARATUS AND METHOD OF CONTROLLING THE SAME

(71) Applicant: HL MANDO CORPORATION, Gyeonggi-do (KR)

(72) Inventor: Seungbae PARK, Gyeonggi-do (KR)

(21) Appl. No.: 19/178,865

(22) Filed: Apr. 15, 2025

(30) Foreign Application Priority Data
Nov. 25, 2024 (KR) 10-2024-0170123

(51) Int. Cl. B60T 17/22; B60T 8/171; B60T 8/172; B60T 8/88; B60T 13/74; H02P 3/04

(52) U.S. Cl. CPC B60T 17/22; B60T 8/171; B60T 8/172; B60T 13/746; H02P 3/04; B60T 8/885; B60T 2220/04; B60T 2240/00; B60T 2270/402; B60T 2270/404; B60T 2270/406; B60T 2270/82

(57) ABSTRACT

A brake apparatus comprises an electromechanical brake module provided in each wheel of a vehicle, and a controller configured to perform braking control on the electromechanical brake module in response to a pedal signal corresponding to brake pedal movement, wherein the electromechanical brake module includes a brake provided in each wheel, a brake motor configured to operate the brake, a motor position sensor outputting a rotor position signal based on the brake motor's rotor position, and a motor controller supplying a drive current corresponding to target motor torque to the brake motor, and whterin the controller identifies a target driving angle based on the target motor torque, identifies an actual driving angle based on the rotor position signal, and identifies the brake motor failure by comparing an angle error between the target and the actual driving angles with a reference angle when an inspection mode is determined.

### CROSS-REFERENCE TO RELATED APPLICATIONS

This application claims the priority of Korean Patent Application No. 10-2024-0170123 filed on Oct. 29, 2024,in the Korean Intellectual Property Office, the disclosure of which is incorporated herein by reference.

### BACKGROUND

### Field

The disclosed disclosure relates to a brake apparatus and a method of controlling the same.

### Description of the Related Art

A vehicle is essentially equipped with a brake system for braking the vehicle. Various types of brake systems have been proposed to obtain a stable, effective braking force.

A general brake system includes a disc configured to rotate together with a vehicle wheel, a caliper having a pair of pad plates installed to be advanced or retracted to press the disc, and a piston installed to be slidable relative to the caliper. The general brake system mainly implements braking of a wheel cylinder by allowing brake oil to press the piston against the disc when a driver presses a brake pedal.

However, recently, as there has been an increasing demand from the market to implement various braking functions in order to appropriately cope with operational environments of vehicles, a technology has been developed that electromechanically generates a braking force by utilizing a motor and various types of gear structures by receiving the driver's braking intention as an electrical signal when the driver presses the brake pedal.

The brake system includes electromechanical brakes respectively mounted in four wheels of the vehicle and configured to operate independently. However, the braking force is not sometimes generated normally during a braking evaluation because the motor is stuck by damage to hardware such as a breakage of a worm wheel.

Because this problem significantly affects the safety of the vehicle, it is necessary to recognize a stuck state of the motor and notify the driver of the stuck state of the motor.

### SUMMARY

An object to be achieved by the present disclosure is to provide a brake system and a motor diagnosis method, which are capable of diagnosing a state of a motor and providing in advance a notification to a driver.

Another object to be achieved by the present disclosure is to provide a brake system and a motor diagnosis method, which are capable of accurately determining the cause, such as performance degradation or damage to hardware, that makes the motor stuck.

One aspect of the disclosed disclosure provides a brake apparatus including: an electromechanical brake module provided in each wheel of a vehicle; and a controller configured to perform braking control on the electromechanical brake module in response to a pedal signal corresponding to a movement of a brake pedal, in which the electromechanical brake module includes: a brake provided in each of the wheels; a brake motor configured to operate the brake; a motor position sensor configured to output a rotor position signal based on a rotor position of the brake motor; and a motor controller configured to supply a drive current, which corresponds to target motor torque, to the brake motor in response to an output signal from the controller, and in which the controller is configured to: identify a target driving angle of the brake motor based on the target motor torque; identify an actual driving angle of the brake motor in response to the rotor position signal; and identify a failure of the brake motor by comparing an angle error between the target driving angle and the actual driving angle with a reference angle when an entry of the brake motor into an inspection mode is determined.

The controller may determine the entry into the inspection mode based on a variation value of the target motor torque within a reference time.

The controller may determine the entry into the inspection mode on the basis that the variation value of the target motor torque is within a reference gradient.

The controller may create mapping data based on the target driving angle and the actual driving angle of the brake motor that does not fail, and the controller may compare the angle error and the reference angle based on the mapping data.

The controller may set a plurality of torque sections based on the target motor torque, linearize the mapping data in each of the plurality of torque sections, and store the linearized mapping data.

The controller may set the target motor torque for initial diagnosis of the brake motor from the mapping data.

The controller may identify a failure of the brake motor in respect to first rotation and second rotation of the brake motor.

The controller may set the first rotation and the second rotation of the brake motor depending on an operation direction of the brake motor related to an operation and a release of the operation of the brake.

The controller may output a warning notification to a driver via an output device provided in the vehicle in response to identifying a failure of the brake motor.

The controller may determine a failure of the brake motor as an abnormal operating state of the brake motor caused by at least one of physical abrasion and breakage of the brake motor.

Another aspect of the disclosed disclosure provides a method of controlling a brake apparatus, which includes an electromechanical brake module including a brake, a brake motor, a motor position sensor, and a motor controller and provided in each wheel of a vehicle, and a controller configured to perform braking control on the electromechanical brake module in response to a pedal signal corresponding to a movement of a brake pedal, the method including: identifying, by the controller, a target driving angle of the brake motor based on target motor torque; identifying, by the controller, an actual driving angle of the brake motor based on a rotor position signal; and identifying, by the controller, a failure of the brake motor by comparing an angle error between the target driving angle and the actual driving angle with a reference angle in an inspection mode for the brake motor.

The method may further include: determining, by the controller, an entry into the inspection mode based on a variation value of the target motor torque within a reference time.

The determining the entry into the inspection mode may comprise determining, by the controller, that the variation value of the target motor torque is within a reference gradient.

The method may further include: creating, by the controller, mapping data based on the target driving angle and the actual driving angle of the brake motor that does not fail; and comparing, by the controller, the angle error and the reference angle based on the mapping data.

The method may further include: setting, by the controller, a plurality of torque sections based on the target motor torque; linearizing, by the controller, the mapping data in each of the plurality of torque sections; and storing, by the controller, the linearized mapping data.

The method may further include: setting, by the controller, the target motor torque for initial diagnosis of the brake motor from the mapping data.

The method may further include: identifying, by the controller, a failure of the brake motor in respect to first rotation and the second rotation of the brake motor.

The controller may set the first rotation and the second rotation of the brake motor based on an operation direction of the brake motor related to an operation and a release of the operation of the brake.

The method may further include: outputting, by the controller, a warning notification to a driver via an output device provided in the vehicle in response to identifying a failure of the brake motor.

The controller may determine a failure of the brake motor as an abnormal operating state of the brake motor caused by at least one of physical abrasion and breakage of the brake motor.

According to one aspect of the disclosed disclosure, it is possible to provide the brake system and the motor diagnosis method, which are capable of diagnosing a state of the motor and providing in advance a notification to the driver.

According to another aspect of the disclosed disclosure, it is possible to provide the brake system and the motor diagnosis method, which are capable of accurately determining the cause, such as performance degradation or damage to hardware, that makes the motor stuck.

Therefore, the brake apparatus and the method of controlling the same may ensure the redundancy capable of coping with the failure of some devices and prevent an increase in costs and an addition of processes due to the addition of other devices.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a configuration of a vehicle according to an embodiment of the disclosed disclosure;

FIG. 2 is a view illustrating a brake apparatus according to the embodiment of the disclosed disclosure and a configuration of the vehicle related to the brake apparatus;

FIG. 3 is a view illustrating an example of an electromechanical brake according to the embodiment of the disclosed disclosure;

FIG. 4 is a view illustrating an example of a connection relationship between components included in the brake apparatus according to the embodiment of the disclosed disclosure;

FIG. 5 is a view illustrating arrangement states of a brake motor and a motor position sensor according to the embodiment of the disclosed disclosure;

FIGS. 6A, 6B and 6C show the controller performing braking control according to the embodiment of the disclosed disclosure;

FIGS. 7A and 7B show the controller linearizing mapping data according to the embodiment of the disclosed disclosure; and

FIG. 8 is a view illustrating a method of controlling the brake system according to the embodiment of the disclosed disclosure.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the embodiments, and the general contents in the technical field to which the disclosed disclosure pertains or the contents repeatedly described in the embodiments will be omitted. The terms ‘part,’ ‘module,’ ‘member,’ ‘block,’ and the like as used in the specification may be implemented in software or hardware. Further, a plurality of ‘part,’ ‘module,’ ‘member,’ ‘block,’ and the like may be embodied as one component. It is also possible that one ‘part,’ ‘module,’ ‘member,’ ‘block,’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

Hereinafter, operation principles and embodiments of the disclosed disclosure will be described in detail with reference to the accompanying drawings.

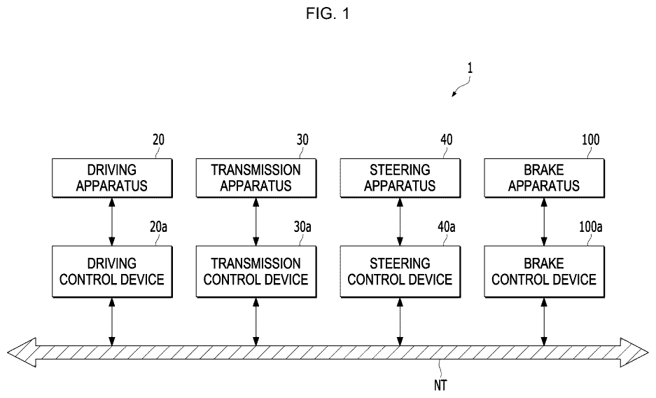

FIG. 1 is a view illustrating a configuration of a vehicle according to an embodiment of the disclosed disclosure.

With reference to FIG. 1, a vehicle 1 may include a driving apparatus 20, a transmission apparatus 30, a steering apparatus 40, and a brake apparatus 100. The driving apparatus 20, the transmission apparatus 30, and the steering apparatus 40 are not essential components, and all or at least some of the above-mentioned components may be excluded. For example, the transmission apparatus 30 may be excluded.

The driving apparatus 20 may provide power for driving the vehicle 1. For example, the driving apparatus 20 may drive or accelerate the vehicle 1 in response to the detection of the driver's acceleration intention inputted through an accelerator pedal.

The driving apparatus 20 may include a motor configured to serve as a driving source for moving the vehicle, and a battery configured to provide energy (electrical energy) to the driving motor that is the driving source. For example, the electric vehicle may include the driving motor as the driving source.

The driving motor may receive electric power from the battery and convert the electrical energy into kinetic energy while the vehicle 1 accelerates. In addition, the driving motor may convert kinetic energy into electrical energy while the vehicle 1 is decelerated or braked. In addition, the driving motor may store the converted electrical energy in the battery. The driving motor may perform regenerative braking in order to decelerate or brake the vehicle.

However, in the driving apparatus 20, a device for recovering energy is not limited to the driving motor. For example, the driving apparatus 20 may selectively further include an alternator. The alternator may convert kinetic energy into electrical energy while the vehicle 1 is decelerated or braked. The alternator may perform regenerative braking in order to decelerate or brake the vehicle.

The driving apparatus 20 may selectively further include an internal combustion engine. For example, a hybrid vehicle may include both the driving motor and the engine as driving sources.

The driving apparatus 20 may include only the motor or may selectively include the motor or the internal combustion engine. In addition, the driving apparatus 20 may not only drive or accelerate the vehicle 1 but also decelerate or brake the vehicle 1 in some instances.

The driving apparatus 20 may include a driving control device 20a configured to control the driving motor. The driving control device 20a may control the driving apparatus 20 in response to the driver's acceleration intention inputted through the accelerator pedal. For example, the driving control device 20a may control a rotational speed and/or torque of the driving apparatus 20. In addition, the driving control device 20a may control regenerative braking by means of the driving motor.

The transmission apparatus 30 may include a plurality of gears and transmit power, which is generated by the driving apparatus 20, to the vehicle wheel.

The transmission apparatus 30 may include a transmission control device (TCU) 30a. The transmission control device 30a may control the transmission apparatus 30 in response to a transmission instruction of the driver inputted through a gear shift lever and/or a traveling speed of the vehicle 1. For example, the transmission control device 30a may control a transmission ratio from the driving apparatus 20 to the vehicle wheel.

The steering apparatus 40 may change a traveling direction of the vehicle 1. For example, the steering apparatus 40 may steer the vehicle 1 in response to the detection of the driver's steering intention inputted through a steering wheel.

The steering apparatus 40 may include a steering control device 40a. The steering control device 40a may assist an operation of the steering apparatus 40 in response to the driver's steering intention inputted through the steering wheel.

The brake apparatus 100 may provide a braking force for braking the vehicle 1. For example, the brake apparatus 100 may decelerate or stop the vehicle 1 in response to the driver's braking intention inputted through a brake pedal and/or a request of a traveling assistance device 100.

The brake apparatus 100 may include a braking control device 100a. The braking control device 100a may control the brake apparatus 100 in response to the driver's braking intention inputted through the brake pedal and/or the motion of the vehicle 1.

The driving apparatus 20, the transmission apparatus 30, the steering apparatus 40, and the brake apparatus 100 may perform communication through a vehicle communication network NT such as Ethernet, media-oriented system transport (MOST), Flexray, controller area network (CAN), and local interconnect network (LIN).

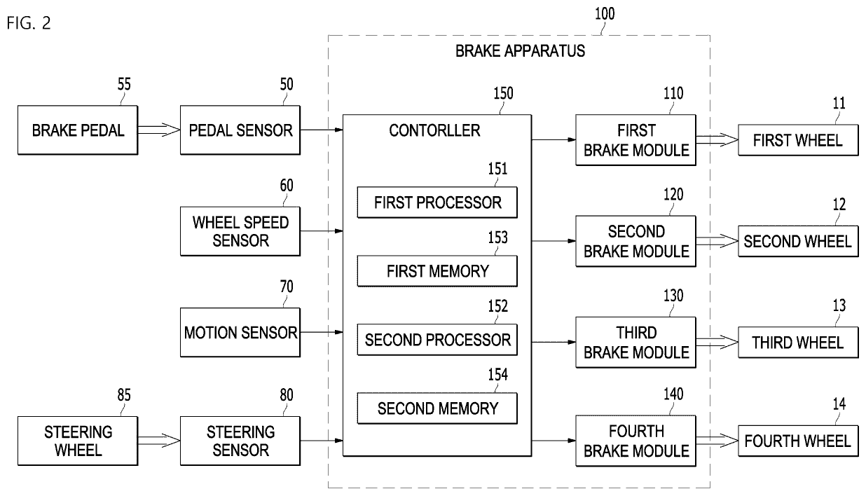

FIG. 2 is a view illustrating a brake apparatus according to the embodiment of the disclosed disclosure and a configuration of the vehicle related to the brake apparatus.

With reference to FIG. 2, the vehicle 1 may include a plurality of wheels 11, 12, 13, and 14 configured to rotate.

For example, the plurality of wheels 11, 12, 13, and 14 may include a first wheel 11 provided at a front left side FL of the vehicle 1, a second wheel 12 provided at a front right side FR of the vehicle 1, a third wheel 13 provided at a rear left side RL of the vehicle 1, and/or a fourth wheel 14 provided at a rear right side RR of the vehicle 1. However, the number of wheels 11, 12, 13, and 14 is not limited to four.

As illustrated in FIG. 2, the vehicle 1 may include a brake pedal 55 configured to acquire an input related to braking from a driver, a pedal sensor 50 configured to detect a movement of the brake pedal 55, a wheel speed sensor 60 configured to detect rotational speeds of the wheels 11, 12, 13, and 14, a steering wheel 85 configured to acquire an input related to steering from the driver, a motion sensor 70 configured to detect a motion of the vehicle 1, a steering sensor 80 configured to detect a rotation of the steering wheel 85, and the brake apparatus 100 configured to provide the plurality of wheels 11, 12, 13, and 14 with braking forces for stopping the vehicle 1. In this case, the pedal sensor 50, the wheel speed sensor 60, the motion sensor 70, and the steering sensor 80 are not essential components, and all or at least some of the above-mentioned components may be excluded.

The brake apparatus 100 may include a plurality of electromechanical brake (EMB) modules 110, 120, 130, and 140 (hereinafter, referred to as brake modules) respectively installed in the wheels 11, 12, 13, and 14, and a controller 150 configured to control the plurality of brake modules 110, 120, 130, and 140.

The plurality of brake modules 110, 120, 130, and 140 may respectively brake the wheels 11, 12, 13, and 14, thereby braking the vehicle 1. For example, the plurality of brake modules 110, 120, 130, and 140 may include a first brake module 110 configured to brake the first wheel 11, a second brake module 120 configured to brake the second wheel 12, a third brake module 130 configured to brake the third wheel 13, and/or a fourth brake module 140 configured to brake the fourth wheel 14. The number of brake modules 110, 120, 130, and 140 is not limited to four.

The plurality of brake modules 110, 120, 130, and 140 may each be operated in response to a braking signal outputted only from the controller 150 without being mechanically or fluidly connected to the brake pedal 55.

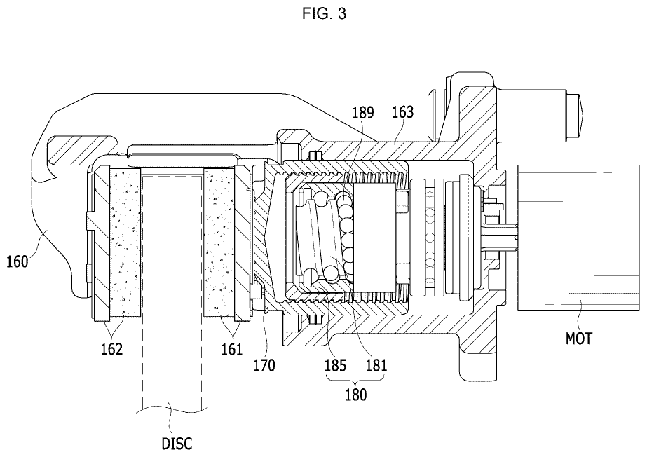

FIG. 3 is a view illustrating an example of an electromechanical brake according to the embodiment of the disclosed disclosure.

For example, as illustrated in FIG. 3, the plurality of brake modules 110, 120, 130, and 140 may each include a caliper brake.

The caliper brake may include a pair of pad plates 161 and 162 installed to press a brake disc DISC configured to rotate together with the plurality of wheels 11, 12, 13, and 14, a caliper housing 160 configured to operate the pair of pad plates 161 and 162, a piston 170 installed in the caliper housing 160 and configured to advance or retract, a power conversion unit 180 configured to receive rotational driving power for moving the piston 170, convert the rotational driving power into linear driving power, and transmit the linear driving power to the piston 170, and a brake motor MOT configured to generate rotational driving power for moving the piston 170. The pad plates 161 and 162, the caliper housing 160, the piston 170, the power conversion unit 180, and the brake motor MOT are not essential components, and all or at least some of the above-mentioned components may be excluded.

The piston 170 may be provided in a cup shape opened at the rear side (right side in FIG. 3) and slidably inserted into a cylinder part 163. In addition, the piston 170 may press the inner pad plate 161 toward the brake disc DISC by receiving power through the power conversion unit 180.

The power conversion unit 180 may include a spindle 181 configured to rotate by receiving driving power from the brake motor MOT, a nut 185 disposed in the piston 170, screw-connected to the spindle 181, and configured to be advanced together with the piston 170 by a rotation of the spindle 181 in a first direction or retracted together with the piston 170 by a rotation of the spindle 181 in a second direction, and a plurality of balls 189 interposed between the spindle 181 and the nut 185. The power conversion unit 180 may be provided as a ball-screw type conversion device configured to convert a rotational motion of the spindle 181 into a linear motion.

A rotational motion of the brake motor MOT may be converted into a linear motion of the piston 170 by the power conversion unit 180. The pair of pad plates 161 and 162 may be compressed toward the brake disc DISC by the linear motion of the piston 170, and the plurality of wheels 11, 12, 13, and 14 may be braked by friction between the pair of pad plates 161 and 162 and the brake disc DISC.

FIG. 3 illustrates the caliper brake as an example of the electromechanical brake. However, the brake is not limited to the caliper brake. For example, the electromechanical brake may include a drum brake.

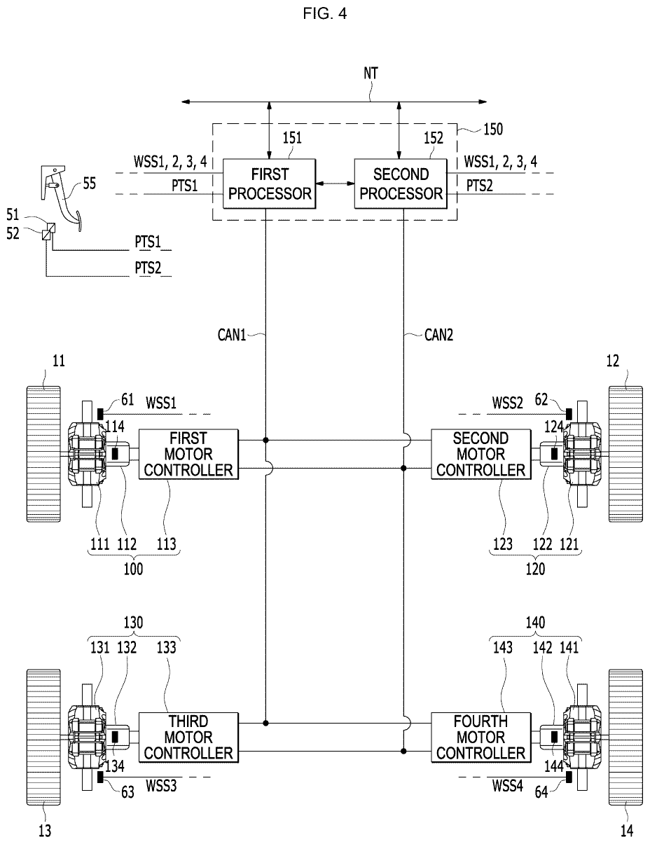

FIG. 4 is a view illustrating an example of a connection relationship between components included in the brake apparatus according to the embodiment of the disclosed disclosure.

With reference to FIG. 4, the plurality of brake modules 110, 120, 130, and 140 may respectively include brakes 111, 121, 131, and 141, brake motors 112, 122, 132, and 142, motor controllers 113, 123, 133, and 143, and motor position sensors 114, 124, 134, and 144.

The first brake module 110 may include a first brake 111, a first brake motor 112, and a first motor controller 113, and the first brake 111, the first brake motor 112, and the first motor controller 113 may be integrated.

The second brake module 120 may include a second brake 121, a second brake motor 122, and a second motor controller 123, and the second brake 121, the second brake motor 122, and the second motor controller 123 may be integrated.

The third brake module 130 may include a third brake 131, a third brake motor 132, and a third motor controller 133, and the third brake 131, the third brake motor 132, and the third motor controller 133 may be integrated.

The fourth brake module 140 may include a fourth brake 141, a fourth brake motor 142, and a fourth motor controller 143, and the fourth brake 141, the fourth brake motor 142, and the fourth motor controller 143 may be integrated.

The brakes 111, 121, 131, and 141 may each include the pad plates configured to brake each of the wheels 11, 12, 13, and 14 by coming into contact with the brake disc DISC configured to rotate together with each of the wheels 11, 12, 13, and 14. The plurality of brakes 111, 121, 131, and 141 may include the first to fourth brakes 111, 121, 131, and 141.

The brake motors 112, 122, 132, and 142 may each be an actuator and each provide torque for moving the pair of pad plates so that the pair of pad plates come into contact with the brake disc DISC. The rotation of each of the brake motors 112, 122, 132, and 142 may be converted into a linear movement by means of the spindle, and the pad plates may be brought into contact with the brake disc DISC by the linear movement of the piston.

The motor controllers 113, 123, 133, and 143 may each control a drive current for rotating each of the brake motors 112, 122, 132, and 142 in response to a braking signal from the controller 150. For example, the motor controllers 113, 123, 133, and 143 may each include an H bridge inverter or a three-phase inverter depending on each of the types of brake motors 112, 122, 132, and 142. In addition, the motor controllers 113, 123, 133, and 143 may each include a driving processor, such as an electronic controller (ECU), configured to receive braking signals from processors 151 and 152 of the controller 150 and control the H bridge inverter or the three-phase inverter to control the drive current of each of the brake motors 112, 122, 132, and 142 in response to the braking signal.

The motor position sensors 114, 124, 134, and 144 may create position data of the brake motors 112, 122, 132, and 142. In this case, the motor position sensors 114, 124, 134, and 144 may each include a Hall sensor. For example, the motor position sensors 114, 124, 134, and 144 may each be a dual-die type sensor.

The motor position sensors 114, 124, 134, and 144 may each generate a position information signal in response to a position of a rotor of each of the brake motors 112, 122, 132, and 142 and output the position information signal. The controller 150 may calculate rotation angles of the brake motors 112, 122, 132, and 142 in response to the position information signals of the rotors.

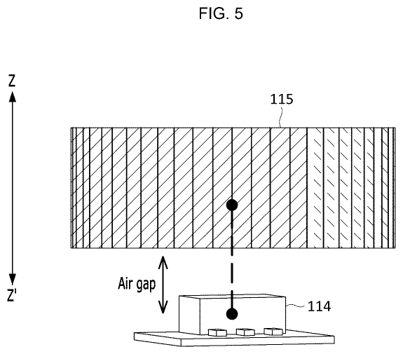

FIG. 5 is a view illustrating arrangement states of a brake motor and a motor position sensor according to the embodiment of the disclosed disclosure.

With reference to FIG. 5, the motor position sensors 114, 124, 134, and 144 may each be spaced apart from a rotor 115 of each of the brake motors 112, 122, 132, and 142 by a predesignated air cap and disposed on the same axis Z-Z′ as the rotor 115. Therefore, the motor position sensors 114, 124, 134, and 144 may each accurately detect a rotational speed and a position of the rotor 115.

Meanwhile, the brake motors 112, 122, 132, and 142 may be damaged by various causes when the brake apparatus 100 operates. For example, failures of the brake motors 112, 122, 132, and 142 may be identified by the controller 150 when the rotors 115 of the brake motors 112, 122, 132, and 142 are axially deformed and the motor position sensors 114, 124, 134, and 144 and the brake motors 112, 122, 132, and 142 are tilted. In other words, the failures of the brake motors 112, 122, 132, and 142 may be set to abnormal operating states of the brake motors 112, 122, 132, and 142 by at least one of physical abrasion and breakage of the brake motors 112, 122, 132, and 142.

The controller 150 may receive output signals from the pedal sensor 50, the wheel speed sensor 60, the motion sensor 70, and/or the steering sensor 80 and control the operations of the plurality of brake modules 110, 120, 130, and 140.

The controller 150 may include the processors 151 and 152 configured to press the output signals from the pedal sensor 50, the wheel speed sensor 60, the motion sensor 70, and/or the steering sensor 80 and output electrical signals, which correspond to a service brake, an EBD, an ABS, a TSC, an ESC, an EPB, and the like, to the plurality of brake modules 110, 120, 130, and 140.

The controller 150 may include the plurality of processors 151 and 152 and a plurality of memories 153 and 154 in order to prepare for damage to or errors of the electric system. For example, the controller 150 may include a first processor 151 and a first memory 153 and include a second processor 152 and a second memory 154 preliminarily. The second processor 152 and the second memory 154 may not be essential components and may be excluded.

The first processor 151 may be separated from the plurality of brake modules 110, 120, 130, and 140 or integrated with any one of the plurality of brake modules 110, 120, 130, and 140.

The first processor 151 may control all the plurality of brake modules 110, 120, 130, and 140 or control only some of the plurality of brake modules 110, 120, 130, and 140. For example, during a normal operation, the first processor 151 integrated with the first brake module 110 may control all the plurality of brake modules 110, 120, 130, and 140.

The first processor 151 may process the output signals from the pedal sensor 50, the wheel speed sensor 60, the motion sensor 70, and/or the steering sensor 80. The first processor 151 may identify braking torque (or braking force, braking acceleration (deceleration), fastening force (clamping force)), which corresponds to the service brake, the EBD, the ABS, the TSC, the ESC, the EPB, and the like, based on the result of processing the output signals and output braking signals, which correspond to the braking torque, to all or some of the plurality of brake modules 110, 120, 130, and 140. The plurality of brake modules 110, 120, 130, and 140, which receive the braking signals, may brake the plurality of wheels 11, 12, 13, and 14 in accordance with the braking forces corresponding to the braking signals.

The first processor 151 may receive a first pedal signal PTS1 from a first pedal sensor 51 and receive first, second, third, and fourth wheel speed signals WSS1, WSS2, WSS3, and WSS4 from first, second, third, and fourth wheel speed sensors 41, 42, 43, and 44. In addition, the first processor 151 may be connected to the vehicle communication network NT. For example, the first processor 151 may receive a lateral acceleration signal and a yaw rate signal, which respectively represent a lateral acceleration and a yaw rate of the vehicle 1, from the motion sensor 70 through the vehicle communication network NT and receive a steering angle signal, which represents a steering angle of the vehicle 1, from the steering sensor 80.

The first processor 151 may be connected to the first, second, third, and fourth motor controllers 113, 123, 133, and 143 through a first communication network CAN1 and communicate with the plurality of motor controllers 113, 123, 133, and 143. In addition, the first processor 151 may be connected to the first, second, third, and fourth motor controllers 113, 123, 133, and 143 through the first communication network CAN1.

For example, the first communication network CAN1 may be an independent exclusive communication network separated from the vehicle communication network NT. Because the first communication network CAN1 is independently separated from the vehicle communication network NT, the braking signal generated by the first processor 151 may be more quickly transmitted to the first, second, third, and fourth brake modules 110, 120, 130, and 140, and the first, second, third, and fourth brake modules 110, 120, 130, and 140 may more quickly brake the plurality of wheels 11, 12, 13, and 14. The first communication network CAN1 may use various communication methods such as Ethernet, media-oriented system transport (MOST), Flexray, controller area network (CAN), and local interconnect network (LIN).

The first processor 151 may provide each of the first, second, third, and fourth brake modules 110, 120, 130, and 140 with a braking signal that represents braking torque (or braking force, braking acceleration (deceleration), or fastening force (clamping force)) for each wheel. For example, the first processor 151 may identify the braking torque required by the driver in response to the first pedal signal PTS1 and distribute the braking torque for the respective wheels to the first, second, third, and fourth brake modules 110, 120, 130, and 140 based on the braking torque required by the driver.

The first processor 151 may identify a slip and/or spin of the first, second, third, or fourth wheels 11, 12, 13, or 14 in response to each of the first, second, third, and fourth wheel speed signals WSS1, WSS2, WSS3, and WSS4 and control each of the first, second, third, and fourth brake modules 110, 120, 130, and 140 based on the slip and/or the spin of the first, second, third, or fourth wheels 11, 12, 13, or 14.

Based on the driver's parking instruction, the first processor 151 may transmit a parking signal for engaging or disengaging a parking brake to the third and fourth brake modules 130 and 140.

As described above, the first processor 151 may provide each of the first, second, third, and fourth brake modules 110, 120, 130, and 140 with a control signal for the EBD, the ABS, the TSC, the ESC, and the EPB.

The first processor 151 may communicate with the second processor 152. For example, the first processor 151 may periodically transmit an electrical signal to the second processor 152. The second processor 152 may identify an operating state (e.g., a normal state or a failure state) of the first processor 151 based on whether the first processor 151 receives the periodic status signal. In addition, the first processor 151 may periodically receive an electrical signal from the second processor 152. The first processor 151 may identify that the second processor 152 is in the normal state based on its receipt of the periodic status signal from the second processor 152. The first processor 151 may identify the failure state (e.g., damage, error, reset, power cut off, or the like) of the second processor 152 based on the fact that the second processor 152 stops receiving the periodic status signal from the second processor 152.

The first memory 153 may store or memorize programs and data for implementing operations of controlling the components included in the braking apparatus 100.

The second processor 152 may be separated from the plurality of brake modules 110, 120, 130, and 140 or integrated with another of the plurality of brake modules 110, 120, 130, and 140.

The second processor 152 may control all the plurality of brake modules 110, 120, 130, and 140 or control only some of the plurality of brake modules 110, 120, 130, and 140. For example, the second processor 152 integrated with the second brake module 120 may control all the plurality of brake modules 110, 120, 130, and 140 while the first processor 151 fails.

The second processor 152 may process the output signals from the pedal sensor 50, the wheel speed sensor 60, the motion sensor 70, and/or the steering sensor 80, identify the braking forces, which correspond to the service brake, the EBD, the ABS, the TSC, the ESC, the EPB, and the like, based on the result of processing the output signals, and output the braking signals, which correspond to the braking forces, to all or some of the plurality of brake modules 110, 120, 130, and 140. The plurality of brake modules 110, 120, 130, and 140, which receive the braking signals, may brake the plurality of wheels 11, 12, 13, and 14 in accordance with the braking forces corresponding to the braking signals.

The second processor 152 may receive a second pedal signal PTS2 from a second pedal sensor 52 and receive the wheel speed signals WSS1, WSS2, WSS3, and WSS4 from the wheel speed sensors 41, 42, 43, and 44. In addition, the second processor 152 may be connected to the vehicle communication network NT independently of the first processor 151. For example, the second processor 152 may receive a yaw rate signal, which represents a yaw rate of the vehicle 1, from the motion sensor 70 through the vehicle communication network NT and receive the steering angle signal, which represents the steering angle of the vehicle 1, from the steering sensor 80.

The second processor 152 may be connected to the plurality of motor controllers 113, 123, 133, and 143 through a second communication network CAN2 and communicate with the plurality of motor controllers 113, 123, 133, and 143 through the second communication network CAN2. For example, the second communication network CAN2 may be an independent exclusive communication network separated from the vehicle communication network NT and the first communication network CAN1. The second communication network CAN2 may use various communication methods such as Ethernet, media-oriented system transport (MOST), Flexray, controller area network (CAN), and local interconnect network (LIN). In addition, the second processor 152 may be connected to the first, second, third, and fourth motor controllers 113, 123, 133, and 143 through the second communication network CAN2.

For example, the second communication network CAN2 may be an independent exclusive communication network separated from the vehicle communication network NT and the first communication network CAN1. Because the second communication network CAN2 is independently separated from the vehicle communication network NT and the first communication network CAN1, the braking signal generated by the second processor 152 may be more quickly transmitted to the plurality of motor controllers 113, 123, 133, and 143, and the plurality of brake modules 110, 120, 130, and 140 may more quickly brake the plurality of wheels 11, 12, 13, and 14. The second communication network CAN2 may use various communication methods such as Ethernet, media-oriented system transport (MOST), Flexray, controller area network (CAN), and local interconnect network (LIN).

The second processor 152 may provide each of the first, second, third, and fourth brake modules 110, 120, 130, and 140 with the braking signal that represents braking torque (or braking force, braking acceleration (deceleration), or fastening force (clamping force)). For example, the second processor 152 may identify the braking torque required by the driver in response to the second pedal signal PTS2 and distribute the braking torque required by the driver to the first, second, third, and fourth brake modules 110, 120, 130, and 140.

The second processor 152 may identify a slip and/or spin of the first, second, third, or fourth wheels 11, 12, 13, or 14 in response to each of the first, second, third, and fourth wheel speed signals WSS1, WSS2, WSS3, and WSS4 and control each of the first, second, third, and fourth brake modules 110, 120, 130, and 140 based on the slip and/or the spin of the first, second, third, or fourth wheels 11, 12, 13, or 14.

Based on the driver's parking instruction, the second processor 152 may transmit a parking signal for engaging or disengaging a parking brake to the third and fourth brake modules 130 and 140.

As described above, the second processor 152 may provide each of the first, second, third, and fourth brake modules 110, 120, 130, and 140 with a control signal for the EBD, the ABS, the TSC, the ESC, and the EPB.

The second processor 152 may communicate with the first processor 151. For example, the second processor 152 may periodically transmit an electrical signal to the first processor 151. The first processor 151 may identify an operating state (e.g., a normal state or a failure state) of the second processor 152 based on whether the second processor 152 receives the periodic status signal. In addition, the second processor 152 may periodically receive an electrical signal from the first processor 151. The second processor 152 may identify that the first processor 151 is in the normal state based on its receipt of the periodic status signal from the first processor 151. The second processor 152 may identify the failure state of the first processor 151 based on the fact that the first processor 151 stops receiving the periodic status signal from the first processor 151.

The second processor 152 may be implemented by semiconductor elements provided separately from the first processor 151. Alternatively, the second processor 152 may be implemented by processing cores provided in a region separated from the first processor 151 in one semiconductor element.

The second processor 152 may have the same computation ability as the first processor 151 or have a lower computation ability than the first processor 151. For example, the number of instructions processed by the second processor 152 per unit time may be equal to or smaller than the number of instructions processed by the first processor 151 per unit time.

The second memory 154 may preliminarily store or memorize programs and data for implementing operations of controlling the components included in the braking apparatus 100.

The first and second memories 153 and 154 may provide the stored program and data to the first and second processors 151 and 152 and memorize temporary data produced during the operations of the first and second processors 151 and 152. For example, the first and second memories 153 and 154 may include volatile memories, such as a static random access memory (S-RAM) and a dynamic random access memory (D-RAM), and non-volatile memories, such as a read-only memory (ROM), an erasable programmable read-only memory (EPROM), and a flash memory.

As described above, the controller 150 may include the first processor 151 and the second processor 152. Therefore, the second processor 152 may control the plurality of brake modules 110, 120, 130, and 140 when the first processor 151 fails. In addition, the first processor 151 may control the plurality of brake modules 110, 120, 130, and 140 when the second processor 152 fails.

For example, the brake pedal 55 may be provided at a lower side of a cabin so that the driver may control the brake pedal 55 with his/her foot. The driver may push the brake pedal 55 in accordance with a braking intention to brake the vehicle 1. In accordance with the driver's braking intention, the brake pedal 55 may depart from a reference position and move.

The pedal sensor 50 may be installed in the vicinity of the brake pedal 55 and measure the movement of the brake pedal 55 made by the driver's braking intention. For example, the pedal sensor 50 may detect a movement distance and/or a movement speed of the brake pedal 55 from a reference position.

The pedal sensor 50 may be electrically connected to the brake apparatus 100 and provide an electrical signal to the brake apparatus 100. For example, the pedal sensor 50 may be connected directly to the brake apparatus 100 through a hard wire or connected to the brake apparatus 100 through a communication network. The pedal sensor 50 may provide the brake apparatus 100 with an electrical signal corresponding to the movement distance and/or the movement speed of the brake pedal 55. In addition, the pedal sensor 50 may be integrated with the brake apparatus 100.

The pedal sensor 50 may include a plurality of pedal sensors in order to prepare for damage to or errors of the electric system. For example, the pedal sensor 50 may include a first sensor and a second sensor. The first and second sensors may each provide the brake apparatus 100 with an electrical signal corresponding to the movement distance and/or the movement speed of the brake pedal 55.

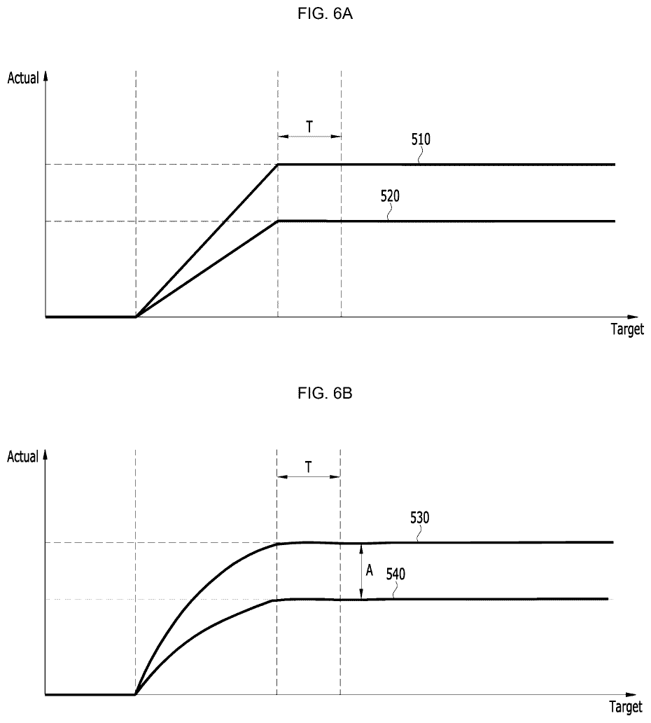

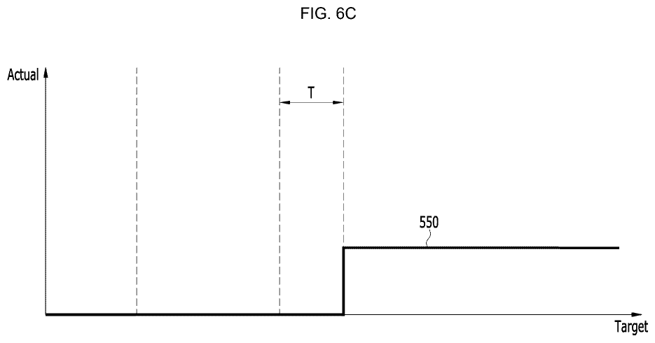

FIGS. 6A, 6B and 6C show a controller performing braking control according to the embodiment of the disclosed disclosure.

With reference further to FIGS. 6A, 6B and 6C, the controller 150 may identify the braking torque required by the driver in response to the first pedal signal PTS1 and perform the braking control on the brake modules 110, 120, 130, and 140 based on the identified required braking torque.

The controller 150 may set target motor torque 510 of the brake motors 112, 122, 132, and 142 in order to perform braking control. In addition, the controller 150 may output the braking control signal to the motor controllers 113, 123, 133, and 143 based on the preset target motor torque 510.

The motor controllers 113, 123, 133, and 143 may supply the drive current, which corresponds to the target motor torque 510, to the brake motors 112, 122, 132, and 142 in response to the braking control signal from the controller 150.

The motor controllers 113, 123, 133, and 143 may monitor actual motor torque 520 generated by the brake motors 112, 122, 132, and 142 and transmit the actual motor torque 520 to the controller 150.

The controller 150 may receive the actual motor torque 520 from the motor controllers 113, 123, 133, and 143 and receive rotor position signals from the motor position sensors 114, 124, 134, and 144.

The controller 150 may identify target driving angles of the brake motors 112, 122, 132, and 142 based on target motor torque. In addition, the controller 150 may identify actual driving angles of the brake motors 112, 122, 132, and 142 in response to the rotor position signals.

When the controller 150 determines entries of the brake motors 112, 122, 132, and 142 into an inspection mode, the controller 150 may compare an angle error A between a target driving angle 530 and an actual driving angle 540 with a reference angle and identify failures of the brake motors 112, 122, 132, and 142. In addition, when the controller 150 identifies the failure of the brake motors 112, 122, 132, and 142, the controller 150 may change a level of a motor stuck flag 550 in order to output a warning notification to the driver. In other words, the controller 150 may perform control to output the warning notification to the driver by changing the level of the motor stuck flag 550.

The controller 150 may determine the entry into the inspection mode based on a variation value of the target motor torque 510 within a reference time T. In more detail, the controller 150 may determine the entry into the inspection mode on the basis that the variation value is within a reference gradient of the target motor torque 510. In this case, the reference time T may be set to about 5 ms, and the reference gradient may be set to about 3% or less. In this case, the reference gradient may be set based on an almost constant value of the target motor torque.

For example, in case that an absolute value of the variation value of the target motor torque 510 inputted to the brake motors 112, 122, 132, and 142 is a gradient of about 3% or less within the reference time T of about 5 ms, the controller 150 may determine the entries of the brake motors 112, 122, 132, and 142 into the inspection mode.

In addition, in the inspection mode for the brake motors 112, 122, 132, and 142, the controller 150 may compare the angle error between the target driving angle and the actual driving angle with the reference angle and identify the failures of the brake motors 112, 122, 132, and 142. In this case, the reference angle may be set to about 10% or more. For example, the brake motors 112, 122, 132, and 142 may be determined as being stuck when the angle error of about 10% or more occurs on the brake motors 112, 122, 132, and 142. In particular, because the angle error may rapidly increase in case that the gear is damaged, it may be necessary to perform an immediate action on the error of about 10% or more when the brake motors 112, 122, 132, and 142 are determined as being stuck.

The controller 150 may create mapping data based on the target driving angle and the actual driving angle of the brake motor that does not fail, and the controller 150 may compare the angle error and the reference angle based on the mapping data.

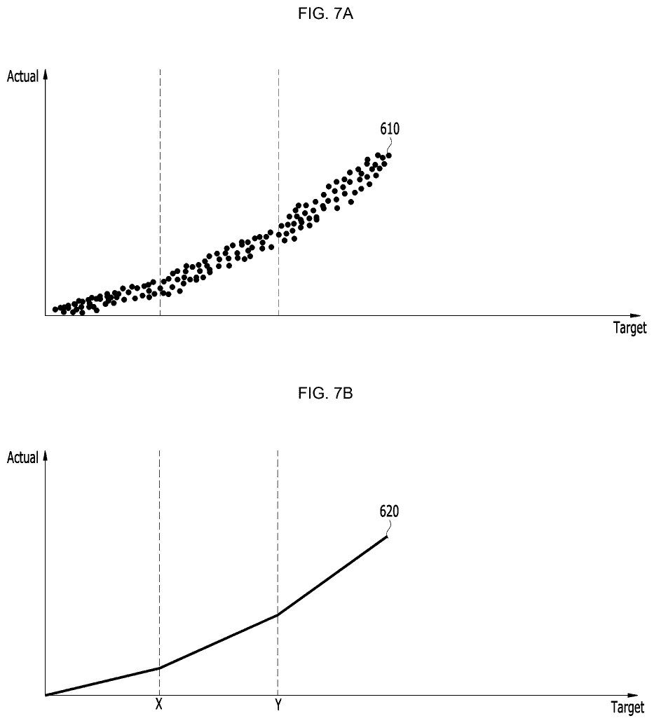

FIGS. 7A and 7B show the controller linearizing mapping data according to the embodiment of the disclosed disclosure

With reference to FIGS. 7A and 7B, the controller 150 may set a plurality of torque sections based on the target motor torque, linearize (620) mapping data 610 in each of the plurality of torque sections, and store the linearized mapping data 610. In this case, the controller 150 may set the plurality of torque sections based on first reference torque X and second reference torque Y.

In this case, the controller 150 may set the target motor torque for initial diagnosis of the brake motor from the mapping data. In this regard, the controller 150 may set the mapping data by applying experimental data and set the target motor torque for the initial diagnosis of the brake motor based on the mapping data.

The controller 150 may identify a failure of the brake motor in respect to first and second rotations of the brake motor. In this case, the first and second rotations of the brake motor may be set depending on the operation direction of the brake motor related to the operation or the release of the operation of the brake.

The controller 150 may output the warning notification to the driver via an output device provided in the vehicle in response to identifying a failure of the brake motor.

According to one aspect of the disclosed disclosure, it is possible to provide the brake system and the motor diagnosis method, which are capable of diagnosing a state of the motor and providing in advance a notification to the driver.

According to another aspect of the disclosed disclosure, it is possible to provide the brake system and the motor diagnosis method, which are capable of accurately determining the cause, such as performance degradation or damage to hardware, that makes the motor stuck.

Therefore, the brake apparatus and the method of controlling the same may ensure the redundancy capable of coping with the failure of some devices and prevent an increase in costs and an addition of processes due to the addition of other devices.

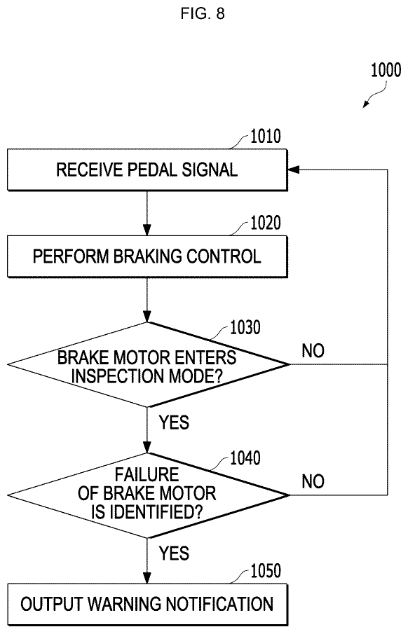

FIG. 8 is a view illustrating a method of controlling the brake apparatus according to the embodiment of the disclosed disclosure.

Hereinafter, a method of controlling the brake apparatus according to the embodiment of the disclosed disclosure will be described.

With reference to FIG. 8, the method of controlling the brake apparatus according to the embodiment of the disclosed disclosure may include identifying, by the controller, the target driving angle of the brake motor based on the target motor torque, identifying the actual driving angle of the brake motor based on the rotor position signal, comparing the angle error between the target driving angle and the actual driving angle with the reference angle in the inspection mode for the brake motor, and identifying a failure of the brake motor.

Specifically, the controller may receive the pedal signal from the pedal sensor (1010), identify the braking torque required by the driver in response to the pedal signal, and perform the braking control on the brake module (1020).

The controller 150 may set the target motor torque 510 of the brake motors 112, 122, 132, and 142 in order to perform the braking control. In addition, the controller 150 may output the braking control signal to the motor controllers 113, 123, 133, and 143 based on the preset target motor torque 510.

The motor controllers 113, 123, 133, and 143 may supply the drive current, which corresponds to the target motor torque 510, to the brake motors 112, 122, 132, and 142 in response to the braking control signal from the controller 150.

The motor controllers 113, 123, 133, and 143 may monitor the actual motor torque 520 generated by the brake motors 112, 122, 132, and 142 and transmit the actual motor torque 520 to the controller 150.

The controller 150 may receive the actual motor torque 520 from the motor controllers 113, 123, 133, and 143 and receive the rotor position signals from the motor position sensors 114, 124, 134, and 144.

The controller 150 may identify the target driving angles of the brake motors 112, 122, 132, and 142 based on the target motor torque. In addition, the controller 150 may identify the actual driving angles of the brake motors 112, 122, 132, and 142 in response to the rotor position signals.

When the controller 150 determines the entries of the brake motors 112, 122, 132, and 142 into the inspection mode, the controller 150 may compare the angle error A between the target driving angle 530 and the actual driving angle 540 with the reference angle and identify failures of the brake motors 112, 122, 132, and 142.

The controller 150 may determine the entry into the inspection mode based on a variation value of the target motor torque 510 within the reference time T. In more detail, the controller 150 may determine the entry into the inspection mode when the variation value is within the reference gradient of the target motor torque 510. The controller 150 may determine to enter the inspection mode based on a determination that the variation value of the target motor torque 510 does not exceed the predetermined reference gradient. In this case, the reference time T may be set to about 5 ms, and the reference gradient may be set to about 3% or less. In this case, the reference gradient may be set based on an almost constant value of the target motor torque.

For example, in case that an absolute value of the variation value of the target motor torque 510 inputted to the brake motors 112, 122, 132, and 142 is a gradient of about 3% or less within the reference time T of about 5 ms, the controller 150 may determine the entries of the brake motors 112, 122, 132, and 142 into the inspection mode (1030).

In addition, in the inspection mode for the brake motors 112, 122, 132, and 142, the controller 150 may compare the angle error between the target driving angle and the actual driving angle with the reference angle and identify the failures of the brake motors 112, 122, 132, and 142 (1040). In this case, the reference angle may be set to about 10% or more. For example, the brake motors 112, 122, 132, and 142 may be determined as being stuck when the angle error of about 10% or more occurs on the brake motors 112, 122, 132, and 142. In particular, because the angle error may rapidly increase in case that the gear is damaged, it may be necessary to perform an immediate action on the error of about 10% or more when the brake motors 112, 122, 132, and 142 are determined as being stuck.

The controller 150 may create mapping data based on the target driving angle and the actual driving angle of the brake motor that does not fail, and the controller 150 may compare the angle error and the reference angle based on the mapping data.

FIGS. 7A and 7B are a view illustrating that the controller according to the embodiment of the disclosed disclosure linearizes mapping data.

With reference to FIGS. 7A and 7B, the controller 150 may set a plurality of torque sections based on the target motor torque, linearize (620) the mapping data 610 in the plurality of torque sections, and store the linearized mapping data 610. In this case, the controller 150 may set the plurality of torque sections based on the first reference torque X and the second reference torque Y.

In this case, the controller 150 may set the target motor torque for the initial diagnosis of the brake motor from the mapping data. In this regard, the controller 150 may set the mapping data by applying experimental data and set the target motor torque for the initial diagnosis of the brake motor based on the mapping data.

The controller 150 may identify a failure of the brake motor in respect to first and second rotations of the brake motor. In this case, the first and second rotations of the brake motor may be set depending on the operation direction of the brake motor related to the operation or the release of the operation of the brake.

The controller 150 may output the warning notification to the driver via an output device provided in the vehicle in response to identifying a failure of the brake motor (1050).

On the other hand, the disclosed embodiments may be implemented in the form of a recording medium that stores computer-executable instructions. The instruction may be stored in the form of a program code. When the instruction is executed by a processor, a program module may be generated, and operations of the disclosed embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

While the disclosed embodiments have been described above with reference to the accompanying drawings, the embodiments are just illustrative and not intended to limit the present specification. It can be appreciated that various modifications and alterations, which are not described above, may be made to the present embodiment by those skilled in the art to which the present specification pertains without departing from the intrinsic features of the present disclosure. The respective constituent elements specifically described in the embodiments may be modified and then carried out. Further, it should be interpreted that the differences related to the modifications and applications are included in the scope of the present specification defined by the appended claims.

What is claimed is:

1. A brake apparatus comprising:
an electromechanical brake module provided in each wheel of a vehicle; and
a controller configured to perform braking control on the electromechanical brake module in response to a pedal signal corresponding to a movement of a brake pedal,
wherein the electromechanical brake module comprises:
a brake provided in each of the wheels;
a brake motor configured to operate the brake;
a motor position sensor configured to output a rotor position signal based on a rotor position of the brake motor; and
a motor controller configured to supply a drive current, which corresponds to target motor torque, to the brake motor in response to an output signal from the controller,
wherein the controller is configured to:
identify a target driving angle of the brake motor based on the target motor torque;
identify an actual driving angle of the brake motor in response to the rotor position signal; and
identify a failure of the brake motor by comparing an angle error between the target driving angle and the actual driving angle with a reference angle when an entry of the brake motor into an inspection mode is determined.

2. The brake apparatus of claim 1, wherein the controller is configured to determine the entry into the inspection mode based on a variation value of the target motor torque within a reference time.

3. The brake apparatus of claim 2, wherein the controller is configured to determine the entry into the inspection mode on the basis that the variation value of the target motor torque is within a reference gradient.

4. The brake apparatus of claim 3, wherein the controller is configured to create mapping data based on the target driving angle and the actual driving angle of the brake motor that does not fail, and compare the angle error and the reference angle based on the mapping data.

5. The brake apparatus of claim 4, wherein the controller is configured to set a plurality of torque sections based on the target motor torque, linearize the mapping data in each of the plurality of torque sections, and store the linearized mapping data.

6. The brake apparatus of claim 5, wherein the controller is configured to set the target motor torque for initial diagnosis of the brake motor from the mapping data.

7. The brake apparatus of claim 1, wherein the controller is configured to identifie a failure of the brake motor in respect to first rotation and second rotation of the brake motor.

8. The brake apparatus of claim 7, wherein the controller is configured to set the first rotation and the second rotation of the brake motor depending on an operation direction of the brake motor related to an operation and a release of the operation of the brake.

9. The brake apparatus of claim 1, wherein the controller is configured to output a warning notification to a driver via an output device provided in the vehicle in response to identifying a failure of the brake motor.

10. The brake apparatus of claim 1, wherein the controller is configured to determine a failure of the brake motor as an abnormal operating state of the brake motor caused by at least one of physical abrasion and breakage of the brake motor.

11. A method of controlling a brake apparatus, which comprises an electromechanical brake module comprising a brake, a brake motor, a motor position sensor, and a motor controller and provided in each wheel of a vehicle, and a controller configured to perform braking control on the electromechanical brake module in response to a pedal signal corresponding to a movement of a brake pedal, the method comprising:
identifying, by the controller, a target driving angle of the brake motor based on target motor torque;
identifying, by the controller, an actual driving angle of the brake motor based on a rotor position signal; and
identifying, by the controller, a failure of the brake motor by comparing an angle error between the target driving angle and the actual driving angle with a reference angle in an inspection mode for the brake motor.

12. The method of claim 11, further comprising:
determining, by the controller, an entry into the inspection mode based on a variation value of the target motor torque within a reference time.

13. The method of claim 12, wherein the determining the entry into the inspection mode comprises determining, by the controller, that the variation value of the target motor torque is within a reference gradient.

14. The method of claim 13, further comprising:
creating, by the controller, mapping data based on the target driving angle and the actual driving angle of the brake motor that does not fail; and
comparing, by the controller, the angle error and the reference angle based on the mapping data.

15. The method of claim 14, further comprising:
setting, by the controller, a plurality of torque sections based on the target motor torque;
linearizing, by the controller, the mapping data in each of the plurality of torque sections; and
storing, by the controller, the linearized mapping data.

16. The method of claim 15, further comprising:
setting, by the controller, the target motor torque for initial diagnosis of the brake motor from the mapping data.

17. The method of claim 11, further comprising:
identifying, by the controller, a failure of the brake motor in respect to first rotation and second rotation of the brake motor.

18. The method of claim 17, wherein the controller sets the first rotation and the second rotation of the brake motor based on an operation direction of the brake motor related to an operation and a release of the operation of the brake.

19. The method of claim 11, further comprising:
outputting, by the controller, a warning notification to a driver via an output device provided in the vehicle in response to identifying a failure of the brake motor.

20. The method of claim 11, wherein the controller determines a failure of the brake motor as an abnormal operating state of the brake motor caused by at least one of physical abrasion and breakage of the brake motor.
